(19) United States
(12) Patent Application Publication
(10) Pub. No.: US 2005/0274269 A1
(43) Pub. Date: Dec. 15, 2005

(54) Device and method for stamping label on tire

(76) Inventors: Kichinosuke Nishimoto, Tokyo (JP); Takao Kokubu, Tokyo (JP); Norimiti Utida, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/513,988

(22) PCT Filed: May 14, 2003
(86) PCT No.: PCT/JP03/05994

§ 371 Date: Jul. 19, 2005

(30) Foreign Application Priority Data
May 14, 2002 (JP) 2002-137892

(51) Int. Cl. B41F 1/08

(52) U.S. Cl. 101/288

(57) ABSTRACT

Tire data on tires successively conveyed to a labeling process from a process preceding the labeling process are read in order of conveyance, and the tire data are printed on labels. Since the tire data on each tire is printed on a label and the label is attached to the tire identified by the tire data printed on the label even if different types of tires are produced in random order, the labels can be attached correctly to the tires identified respectively by the tire data. Since the tire data is printed on a blank label immediately before attaching the label to the tire, it is not necessary to prepare labels printed with tire data and it is possible to use only a single kind of blank labels, which is advantageous in respect of space and amount of work.

### TECHNICAL FIELD

The present invention relates to a labeling system and a labeling method for attaching tire identifying labels to tires in a tire producing process, such as a tire manufacturing process or a tire inspecting process.

### BACKGROUND ART

In a process of continuously producing different, types of tires, the tires must be identified so that the tires may not be subjected to wrong processes.

It is important to attach identification labels particularly to green tires before being subjected to a vulcanizing process in a tire manufacturing process to enable the accurate identification of the types of the green tires. Unless the green tires can be accurately identified, it is possible that the green tires are subjected to wrong vulcanizing processes.

The following labeling methods have been prevalently used.

(1) A first labeling method attaches labels individually printed with an identification code (barcode) to one lot of tires.

(2) A second labeling method prepares and unwinds a roll of the same labels identifying one type of tires to which the labels are to be attached among those respectively of different labels identifying different types of tires, and attaches the unwound labels to the tires.

(3) A third labeling method unwinds a roll having serially arranged series of labels respectively printed with barcodes respectively identifying tires of different sizes, and attaches the series of labels identifying tires of different sizes successively to series of tires of different sizes carried in lots discriminated by tire size.

The labeling method (1) requires grouping produced tires in lots respectively of tires of different sizes and spoils the flexibility of free production of different types of tires.

The labeling method (2) needs to prepare a number of rolls respectively of different labels corresponding to the number of types of tires to be produced, which is very disadvantageous in respect of space and amount of work needed.

The method (3) needs to change the order of the series of labels and to make a roll having series of labels arranged in another order if tires of different sizes cannot be produced in an initially scheduled order due to troubles in the production lines and the schedule of production of tires is changed.

### DISCLOSURE OF THE INVENTION

The present invention has been made in view of those problems and it is therefore an object of the present invention to provide a labeling system capable of improving the flexibility and productivity of a tire producing line and of efficiently using space, and a labeling method to be carried out by the labeling system.

A labeling system in a first aspect of the present invention includes: a tire data read means for reading tire data respectively on successively conveyed tires in order of conveyance in a tire producing process; a printing means for printing the tire data on the tires on labels; and a label attaching means for attaching the labels to the tires, respectively.

The labeling system includes the tire data reading means and the printing means in addition to the label attaching means, reads the tire data in order of conveyance of the tires successively delivered from a process preceding a labeling process, and prints the tire data on the labels. Therefore, the tire data on the successively delivered different types of tires are printed on the labels, respectively, in order of delivery of the different types of tires and the labels printed with the tire data specifying the different types of tires can be correctly attached to the different types of tires even if the different types of tires are conveyed in random order, and the productivity and the flexibility of the tire production line can be improved.

The tire data is printed on blank labels, printed labels do not need to be prepared beforehand, and only a single kind of blank labels can be used. Thus the labeling system is advantageous in respect of both space and amount of work.

The labeling system may further include a label reading means for reading tire data printed on the labels attached to the tires, and a collating means for collating the tire data read from the label attached to the tire by the label reading means with the tire data read by the tire data reading means. Thus, it is possible to decide whether or not the tire is correctly labeled.

The printing means may print a barcode representing the tire data. The barcode printed on the label can be quickly and accurately read, and necessary tire data can be printed on a small label.

The successively conveyed tires may be green tires individually carried by carts, respectively, the tire data reading means may be an ID card reader that reads the tire data recorded on an ID card attached to the cart. Thus the label printed with accurate tire data correctly identifying the type of the green tire can be attached to the green tire and hence it is possible to avoid subjecting the green tire to a wrong vulcanizing process.

A labeling method of attaching labels to tires in a tire manufacturing process in a second aspect of the present invention includes: a tire data reading step of reading tire data on successively conveyed tires in order of conveyance; a printing step of printing tire data on the tires on labels; and a label attaching step of attaching the label to the tire.

The tire data on the successively conveyed tires are read in order of conveyance, the read tire data are printed on the labels, respectively, and the labels are attached to the tires, respectively. Therefore, the tire data identifying the individual tires are printed on the labels, the labels can be attached correctly to the tires identified respectively by the tire data, and the flexibility of production can be insured.

Even if individual different types of tires are conveyed successively in random order in the tire data reading step, correct labeling can be achieved.

A labeling method of attaching labels to tires in a tire manufacturing process in a third aspect of the present invention may include: a tire data reading step of reading tire data on successively conveyed tires in order of conveyance; a label separating step of separating labels successively mounted on a supporting strip so as to extend fully across the supporting strip and separated from each other by a slit one by one from the supporting strip while the labels are being carried by the supporting strip; a label carrying step of carrying the label separated from the supporting strip at a label carrying speed higher than a moving speed at which the supporting strip moves; a printing step of printing tire data on the carried labels; and a label attaching step of attaching the printed label to the tire.

Since the labels are mounted successively on the supporting strip so as to extend fully across the supporting strip, the amount of the supporting strip to be disposed of can be reduced and material costs can be reduced.

Since the label separated from the supporting strip is carried at a high label carrying speed to a printing station where the printing step is executed, the interval between the preceding and the succeeding label increases and hence any part of data to be printed on the preceding label will not be faultily printed on the succeeding label.

### BRIEF DESCRIPTION OF THE DRAWINGS

FIG. 1 is a schematic view of a labeling system in a preferred embodiment of the present invention applied to a tire manufacturing process;

FIG. 2 is a schematic side elevation of a label printing-and-attaching machine included in the labeling system shown in FIG. 1;

FIG. 3 is a block diagram of a control system included in the labeling system shown in FIG. 1;

FIG. 4 is a flow chart of a control procedure to be carried out by the control system shown in FIG. 3;

FIG. 5 is a fragmentary perspective view of a supporting strip and labels supported on the supporting strip; and

FIG. 6 is a schematic side elevation of a label printing-and-attaching machine included in a labeling system in another embodiment of the present invention.

### BEST MODE FOR CARRYING OUT THE INVENTION

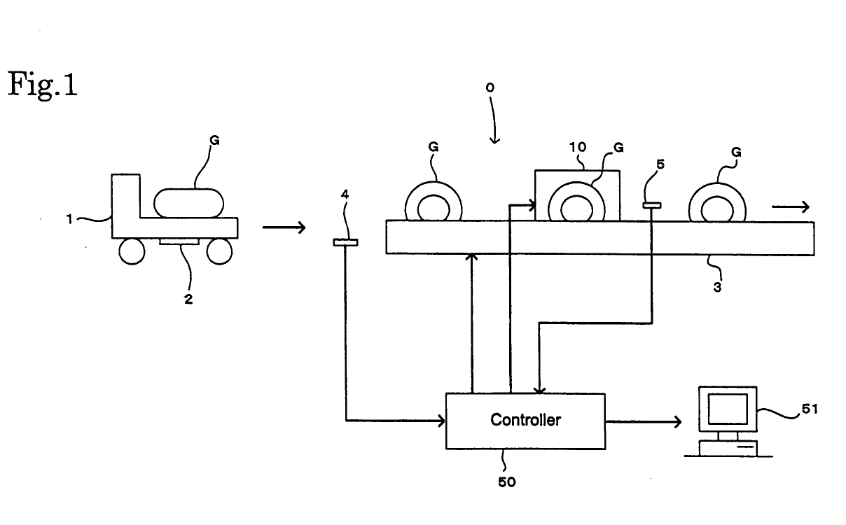

A labeling system in a preferred embodiment of the present invention will be described with reference to FIGS. 1 to 4.

FIG. 1 shows a labeling system O applied to a tire manufacturing process in a schematic view.

A green tire G manufactured by a first forming process, i.e., a tire not yet vulcanized, is carried by a cart 1 to a labeling station.

Various types of green tires G manufactured by different first forming processes, respectively, are carried individually by carts 1 respectively for carrying the different types of green tires G to the labeling station. Therefore, different types of green tires G are delivered in random order to a tire conveying machine 3 installed at the labeling station.

ID cards 2 are attached to the carts 1 respectively for carrying the different types of green tires G, respectively. Data including size, material, date, serial number and such about the green tire G on the cart 1 is recorded in each ID card.

An ID card reader 4 is disposed near the tire conveying machine 3. The ID card reader 4 reads the tire data recorded on the ID cared 2 attached to the cart 1 holding the green tire G when the green tire G is carried to the tire conveying machine 3.

After the ID card reader 4 has read the tire data, the green tire G is transferred from the cart 1 to the tire conveying machine 3, and the tire conveying machine 3 conveys the green tire G.

A label printing-and-attaching machine 10 is disposed at a position corresponding to a middle section of the tire conveying machine 3.

A barcode reader 5 is disposed below the label printing-and-attaching machine 10 with respect to a direction in which the tire conveying machine 3 conveys the green tire G.

The label printing-and-attaching machine 10 and the tire conveying machine 3 are controlled by a controller 50. The controller 50 makes a display 51, such as a CRT or a liquid crystal display, display results of data processing operations.

Pieces of tire data read by the ID card reader 4 and the barcode reader 5 are given to the controller 50.

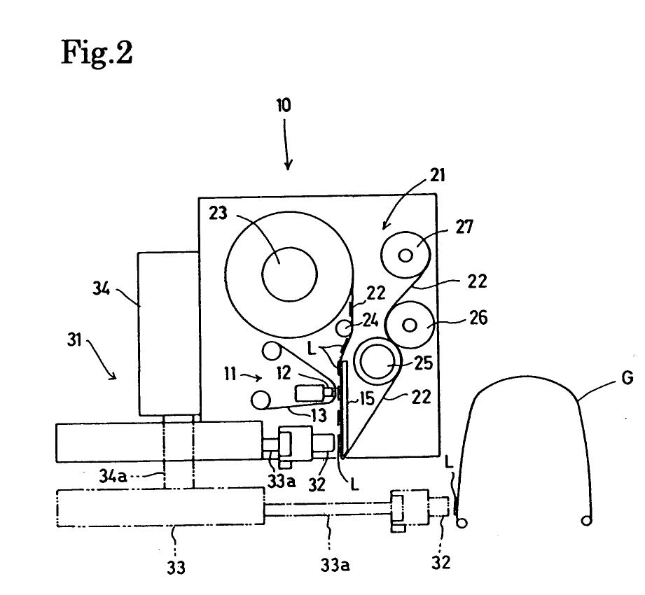

The configuration of the label printing-and-attaching machine 10 will be described with reference to FIG. 2.

The label printing-and-attaching machine 10 has a printer 11, a label feed mechanism 21 and a label attaching mechanism 31.

The printer 11 is a thermal transfer printer. The printer 11 may be any suitable printer other than the thermal transfer printer, such as an ink jet printer. An ink ribbon 13 moves through a space in front of a thermal print head included in the printer 11.

A vertical guide plate 15 is disposed opposite to the thermal print head 12.

The label feed mechanism 21 moves a supporting strip 22. Labels L are attached in a successive arrangement to a repellent front surface of the supporting strip 22. The labels L have back surfaces coated with an adhesive. The labels L are attached temporarily to the repellent front surface of the supporting strip 22 and can be released from the supporting strip 22.

The supporting strip 22 holding the blank labels L in a successive arrangement is rolled in a roll. The roll of the supporting strip 22 is held on a holding roller 23 disposed above the printer 11.

The supporting strip 22 unwound from the roll of the supporting strip 22 held on the holding roller 23 travels through an idle roller 24, is guided vertically downward by the guide plate 15, is folded back at the lower end of the guide plate 15, is pinched between a pair of unwinding roller 25 and 26, and is taken up on a take-up roller 27.

The supporting strip 22 pinched between the unwinding rollers 25 and 26 is pulled and unwound from the roll held on the holding roller 23 by driving the unwinding roller 25. Thus the labels L are moved onto the guide plates 15.

The thermal print head 12 of the printer 11 is opposed to an upper half part of the guide plate 15. The thermal print head 12 is able to print data on a blank label L held on the supporting strip 22.

A suction pad 32 included in the label attaching mechanism 31 is disposed opposite to a lower half part of the guide plate 15. The suction pad 32 is capable of attracting a label L by suction.

The label attaching mechanism 31 includes a vacuum device for attracting a label L to the suction pad 32 by suction, a double-acting cylinder actuator 33 for advancing and retracting a rod 33a holding the suction pad at its front end, and a linear cylinder actuator 34 for advancing and retracting a rod 34 having an end joined to the double-acting cylinder actuator 33 in directions perpendicular to directions in which the rod 33 is advanced and retracted.

A label L printed with tire data by the printer 11 and held on the supporting strip 22 is advanced to a position corresponding to the lower half part of the guide plate 15. Then, the double-acting cylinder actuator 33 is actuated to take the label L off the supporting strip 22 by attracting the label L to the suction pad 32 by suction. Then, the linear cylinder actuator 34 advances the rod 34a, and the double-acting cylinder actuator 33 advances the rod 33a to attach the label L to the green tire G set at a predetermined position by pressing the label L against a predetermined part of the side wall of the green tire G near a bead as indicated by two-dot chain lines in FIG. 2.

After the label L has been attached to the green tire G, a vacuum created in the suction pad 32 is relieved, and the suction pad 32 is separated from the green tire G and is returned to its home position indicated by continuous lines in FIG. 2.

After the label L has been taken off the supporting strip 22 at the position corresponding to the lower half part of the guide plate 15, the supporting strip 22 is folded back at the lower end of the guide plate 15. The pair of unwinding rollers 25 and 26 delivers the unloaded part of the supporting strip 22 to the take-up roller 27, and the take-up roller 27 takes up the unloaded part of the supporting strip 22.

The controller 50 controls those operations of the printer 11, the label feed mechanism 21 and the label attaching mechanism 31 of the label printing-and-attaching machine 10.

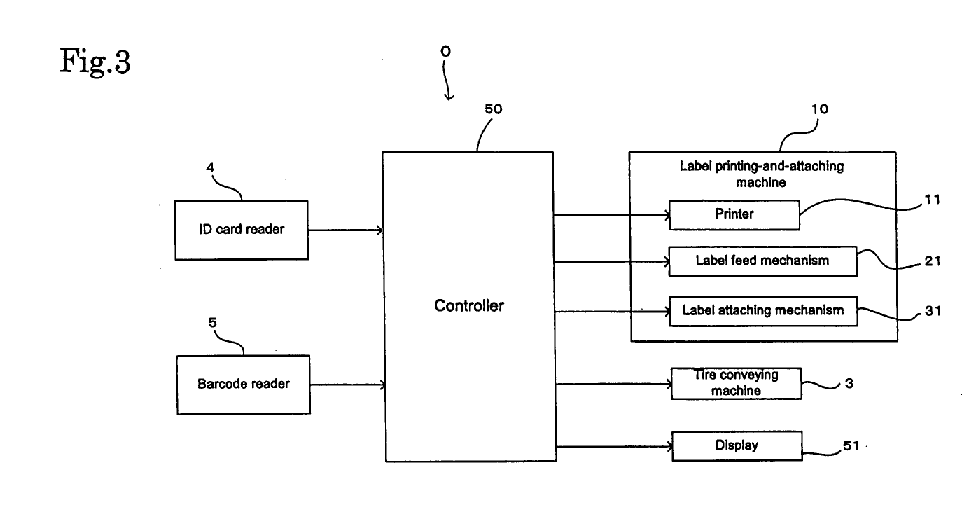

Referring to a block diagram of a control system shown in FIG. 3, the controller 50 receives and processes signals provided by the ID card reader 4 and the barcode reader 5, controls the label printing-and-attaching machine 10 and the tire conveying machine 3, and makes the display 51 display data obtained by processing the signals.

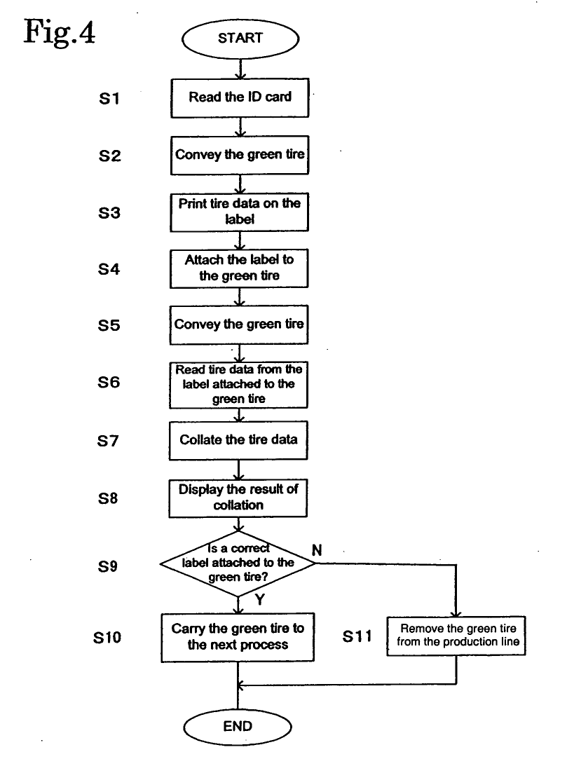

Those operations will be described with reference to FIG. 4 showing a flow chart of a control procedure to be carried out by the control system.

When the green tire G is transferred from the cart 1 to the tire conveying machine 3, the ID card reader 4 reads data on the green tire G from the ID card 2 attached to the cart 1 in step S1.

The tire conveying machine 3 conveys the green tire G in step S2, while a barcode representing tire data read by the ID card reader 4 is printed on a blank label L held on the supporting strip 22 in step S3.

When the green tire G conveyed in step 2 is set at a label attaching position in the label printing-and-attaching machine 10, the label L printed with the tire data on the green tire G is attracted to the suction pad 32, and the label attaching mechanism 31 attaches the label L to the green tire G in step S4.

Then, while the green tire G provided with the label L is being conveyed further from the label attaching position in step S5, the barcode reader 5 reads the barcode printed on the label L in step S6.

The tire data read by the barcode reader 5 is collated with the tire data on the green tire G read by the ID card reader 4 in step S7, and the result of collation is displayed by the display 51 in step S8.

A query is made in step S9 to see whether or not the tire data read by the barcode reader 5 coincides with the tire data read by the ID card reader 4. If the response to the query made in step S9 is affirmative, the control procedure goes to step S10 to carry the green tire G to the next process. If the response to the query made in step S9 is negative, the control procedure goes to step S11 to remove the green tire G from the production line.

Thus the printer 11 combined with the label attaching mechanism 31 prints the tire data on the green tire G on the label L before the label L is attached to the green tire G. Therefore, even if different types of green tires are produced in random order and are delivered to the tire conveying machine 3 in random order, a label L printed beforehand with the tire data on each green tire G is attached accurately to the green tire G specified by the tire data and hence the flexibility of production can be insured.

Since the tire data read by the barcode reader 5 is collated with the tire data read by the ID card reader 4 for collation, it is possible to insure that the label L printed with the correct tire data on the green tire G is attached to the same green tire G. Thus the correct labels L can be accurately attached to the green tires G.

If the timing of operation of the label feed mechanism 21 for feeding supporting strip 22 is incorrect it is possible that a wrong label L is attached to the green tire G. Such a trouble never arises as long as the label feed mechanism 21 operates normally. Even if such a trouble occurs by any chance, correct labels L can be attached to the relevant green tires G and the influence of the trouble can be confined to the least extent by adjusting the operation of the label feed mechanism 21 upon the detection of a wrong label L. Thus the production line operates at an improved productivity.

Since the supporting strip 22 supporting blank labels L can be stored in rolls, different kinds of labels printed with different tire data do not need to be stored, which is advantageous in respect of space and amount of work.

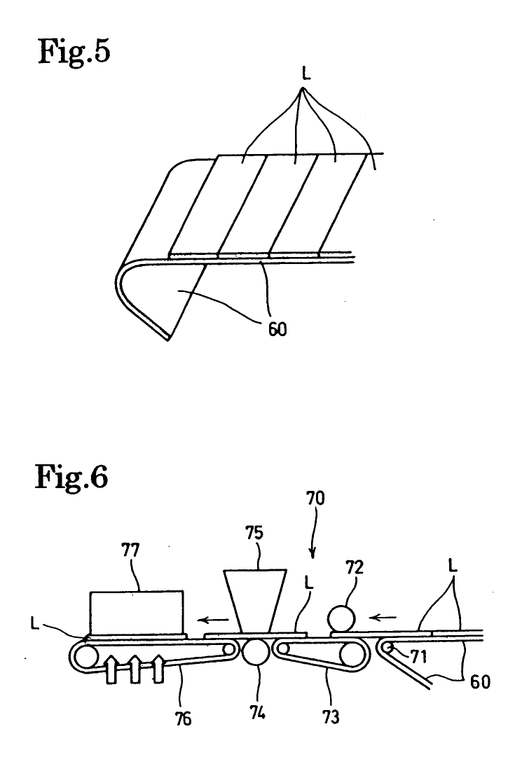

Since labels L are successively mounted on a supporting strip 60 so as to extend fully across the supporting strip 60 and separated from each other by a slit as shown in FIG. 5, the amount of the supporting strip 60 to be disposed of can be reduced to the least possible extent, the supporting strip 60 is not wasted and material costs can be reduced.

If the labels L coated with an adhesive layer are arranged continuously, and a first label L is removed from the supporting strip, a second label L contiguous with the first label L will come off the supporting strip together with the first label L because the first and the second labels L are connected by the adhesive layer or part of tire data to be printed on the label L is liable to be printed on the second label L.

A label printing-and-attaching machine 70 shown in FIG. 6 can be used to avoid such a trouble.

A rolled supporting strip 60 supporting blank labels L in a successive arrangement is unrolled and is advanced in the direction of the arrows. The supporting strip 60 is wound round a small-diameter roller 71 so that only the supporting strip 60 reverses and the blank label L separates from the supporting strip 60. The blank label L separated from the supporting strip 60 is pinched between a feed roller 72 and a release conveyor belt 73 having a release outer surface and is conveyed by the conveyor belt 73.

A release platen roller 74 is disposed below the release conveyor belt 73 with respect to the moving direction of the blank label L. A print head 75 is opposed to the release platen roller 74.

The respective surface speeds of the feed roller 72 and the release conveyor belt 75 is raised temporarily immediately after the blank label being conveyed by the feed roller 72 and the release conveyor belt 73 has separated completely from the supporting strip 60. Thus the distance between the blank label L separated from the supporting strip 60 and the succeeding blank label L is increased intentionally so that the former blank label L is surely spaced apart from the succeeding blank label.

Consequently, separation of successive blank labels L from the supporting strip 60 can be avoided.

After the preceding blank label L has been spaced a predetermined distance from the succeeding blank label L, the surface speeds of the feed roller 72 and the release conveyor belt 73 are lowered to return the feed roller 72 and the release conveyor belt 73 to their normal surface speeds.

The print head 75 prints tire data on the blank label L separated from the succeeding blank label L and hence any part of the tire data to be printed on the preceding blank label L will not be printed on the succeeding blank label L.

A belt conveyor 76 having a plurality of endless belts is disposed below the release platen roller 74 with respect to the conveying direction. A suction head 77 picks up the label L printed with the tire data from the belt conveyor 76.

Air is blown through spaces between the endless belts while the belt conveyor 76 is carrying the label L printed with the tire data, and the suction head attracts the label L by suction. The suction head 77 carries the label L to and attaches the same to a green tire.

The present invention is capable of correctly attaching labels to different types of tires even if those tires are produced in random order and are subjected to labeling in random order. Naturally, the present invention is applicable to label a lot of the same type of tires.

### INDUSTRIAL APPLICABILITY

The present invention is applicable to tire producing processes.

1. A labeling system comprising: a tire data read means for reading tire data respectively on successively conveyed tires in order of conveyance in a tire producing process;
a printing means for printing the tire data on the tires on labels; and
a label attaching means for attaching the labels to the tires, respectively;
a label reading means for reading tire data printed on the labels attached to the tires; and
a collating means for collating the tire data read from the label attached to the tire by the label reading means with the tire data read by the tire data reading means.

2. (canceled)

3. The labeling system according to claim 1, wherein the printing means prints a barcode representing the tire data.

4. The labeling system according to claim 1, wherein the successively conveyed tires are green tires individually carried by carts, respectively, and
the tire data reading means is an ID card reader that reads the tire data recorded on an ID card attached to the cart.

5. A labeling method of attaching labels to tires in a tire manufacturing process comprising:
a tire data reading step of reading tire data on successively conveyed tires in order of conveyance;
a printing step of printing tire data on the tires on labels; and
a label attaching step of attaching the labels to the tires;
a label reading step of reading the tire data printed on the labels attached to the tires in the label attaching step; and
a collating step of collating the tire data read in the label reading step with the tire data read in the label reading step to determine if the tire is correctly labeled.

6. (canceled)

7. The labeling method according to claim 5, wherein different types of fires are carried individually successively in the tire data reading step.

8. A labeling method of attaching labels to fires in a fire manufacturing process comprising:
a fire data reading step of reading tire data on successively conveyed fires in order of conveyance;
a label separating step of separating labels successively mounted on a supporting strip so as to extend fully across the supporting strip and separated from each other by a slit one by one from the supporting strip while the labels are being carried by the supporting strip;
a label carrying step of carrying the label separated from the supporting strip at a label carrying speed higher than a moving speed at which the supporting strip moves;
a printing step of printing fire data on the label separated from the supporting strip; and
a label attaching step of attaching the label printed with the tire data to the fire.
